(19) United States
(12) Patent Application Publication
(10) Pub. No.: US 2022/0243469 A1
(43) Pub. Date: Aug. 4, 2022

(54) Engineered Timber Panel For Structural Use And Method Of Formation Thereof

(71) Applicant: Timberworks Industrial Group Pty Ltd, South Melbourne (AU)

(72) Inventor: Theodore Kerlidis, South Melbourne (AU)

(73) Assignee: Timberworks Industrial Group Pty Ltd, South Melbourne (AU)

(21) Appl. No.: 17/620,461

(22) PCT Filed: Jun. 15, 2020
(86) PCT No.: PCT/AU2020/050603

§ 371 Date: Dec. 17, 2021

(30) Foreign Application Priority Data
Jun. 18, 2019 (AU) 2019902110

(51) Int. Cl. E04C 2/12; E04B 2/00; B32B 21/04

(52) U.S. Cl. CPC E04C 2/12; E04C 2/46; B32B 2607/00; B32B 2250/02; B32B 21/042

(57) ABSTRACT

A method of manufacturing a structural panel for building construction, comprising: subjecting timber feedstock to machine stress grading wherein individual timber sticks that satisfy the grading criteria are allocated a stress grade for structural use; selecting from the timber sticks that fail to satisfy the machine stress grading standard criteria, laminas for forming a panel; arranging the selected timber laminas, without regard to visual defects, in side-by-side parallel formation; and fabricating a structural panel wherein the selected timber laminas are arranged side-by-side parallel to one another with adhesive applied between each adjacent stick incorporated into the panel.

### TECHNICAL FIELD

This invention relates to engineered timber panels for use in building structures, methods for manufacturing such timber panels and buildings constructed therefrom.

### BACKGROUND OF THE INVENTION

There are a number of different construction systems commonly used for house construction in Australia, such as timber framing, steel framing, masonry and concrete panel. Timber and steel framed structures are typically finished with surfaces of relatively lightweight, non-structural cladding panels, whereas masonry and concrete walls are forms of solid mass construction.

From an environmental impact point of view, timber structures have a number of advantages. For example, in terms of carbon emissions and storage:

Carbon released and stored in the
manufacture of building materials

| | Carbon released | Carbon released | Carbon stored |
|---|---|---|---|
| Material | (kg/t) | (kg/m³) | (kg/m³) |
| Sawn timber | 30 | 15 | 250 |
| Steel | 700 | 5,300 | 0 |
| Concrete | 50 | 120 | 0 |
| Aluminium | 8,700 | 22,000 | 0 |

Embodied energy is another important point of differentiation between construction systems:

Embodied energy (EE) per unit area of assembly over life span

| | | | Total EE - |
|---|---|---|---|
| | Initial EE of | Maintenance EE - | 40 yr. life |
| Material | walls (MJ/m²) | 40 yr. (MJ/m²) | cycle (MJ/m²) |
| Timber frame, | 31,020 | 24,750 | 55,770 |
| timber clad, | | | |
| painted | | | |
| Timber frame, | 92,565 | nil | 92,565 |
| brick veneer, | | | |
| unpainted | | | |
| Double brick, | 141,900 | nil | 141,900 |
| unpainted | | | |
| Autoclaved aerated | 76,560 | 24,750 | 101,310 |
| concrete, painted | | | |
| Steel frame, | 75,900 | 24,750 | 100,650 |
| fibre cement | | | |
| clad, painted | | | |

Embodiments of the present invention exploit modern-day timber milling practices to provide a cost effective system for building construction that combines the advantages of a solid mass construction with the environmental benefits of timber materials.

### SUMMARY OF THE INVENTION

In accordance with the present invention there is provided a method of manufacturing a structural panel for building construction, comprising: subjecting timber feedstock to machine stress grading wherein individual timber sticks that satisfy the grading criteria are allocated a stress grade for structural use; selecting from the timber sticks that fail to satisfy the machine stress grading standard criteria, laminas for forming a panel; arranging the selected timber laminas, without regard to visual defects, in side-by-side parallel formation; and fabricating a structural panel wherein the selected timber laminas are arranged side-by-side parallel to one another with adhesive applied between each adjacent stick incorporated into the panel.

Surprisingly, it has been found that panels manufactured according to embodiments of the invention, although made from timber machine graded as not suitable for structural application, exceed measurable criteria for structural use, and expectations, when tested. In contrast to prior art systems, visual inspection of the laminas and/or specific arrangement thereof according to visual defects has been found to be unnecessary. Moreover, unlike prior art systems re-sawing is not required.

The present invention also provides a timber panel for structural use in buildings, manufactured according to the method of the invention.

The present invention further provides a building comprising one or more structural walls formed from at least one timber panel manufactured according to the method of the invention.

### BRIEF DESCRIPTION OF THE DRAWINGS

Further aspects, features and advantages of the present invention may be better understood from the following description of embodiments thereof, presented by way of example only, and with reference to the accompanying drawings, wherein:

FIGS. 1, 2 and 3 diagrammatically illustrate timber machine grading employed in embodiments of the invention;

FIG. 4 is a flow-chart diagram of a process for manufacturing panels according to an embodiment of the invention;

FIG. 5 is a diagrammatic illustration of timber feedstock for forming panels according to embodiments of the invention;

FIG. 6 is a diagrammatic illustration of a timber panel for structural building according to a first embodiment of the invention;

FIG. 7 is a diagrammatic illustration of a timber panel for structural building according to a second embodiment of the invention;

FIG. 8 is a diagrammatic illustration of a timber panel for structural building according to a third embodiment of the invention;

FIG. 9 is a diagrammatic illustration of a building structure formed from timber panels according to embodiments of the invention;

FIGS. 10 to 12 are diagrams showing results from testing embodiments of the invention; and

FIG. 13 is a table indicating structural design properties for F-grade timbers.

### DETAILED DESCRIPTION

Structural timber is generally sold as a stress graded product. A stress grade is the classification of a timber when used in structural applications, according to the requirements of Australian Standard AS 1720.1 for example. Stress grades are derived from either visual- or machine-grading, which specify the stress limits that apply to timbers used for structural applications. Stress grades are known by either:
‘F’ grades—F4 to F34. For example F14 indicates that the basic working stress (in bending) for that timber is around 14 MPa.
Machine-graded pine MGP—MGP10 to MGP15. For example MGP10 indicates a minimum threshold for stiffness properties of 10,000 MPa. Currently, nearly all exotic plantation softwoods (Pinus species) are graded using this system.

Structural grading is based on correlation between strength and a grading parameter. In the case of machine stress grading, that relates to stiffness on the flat side of the timber stick, i.e. minor axis modulus of elasticity. Timber that is unable to meet the grading criteria required for structural use is sold as utility grade or merchant grade timber. Understandably, this grade of timber is substantially less expensive to purchase, since its scope for application is limited.

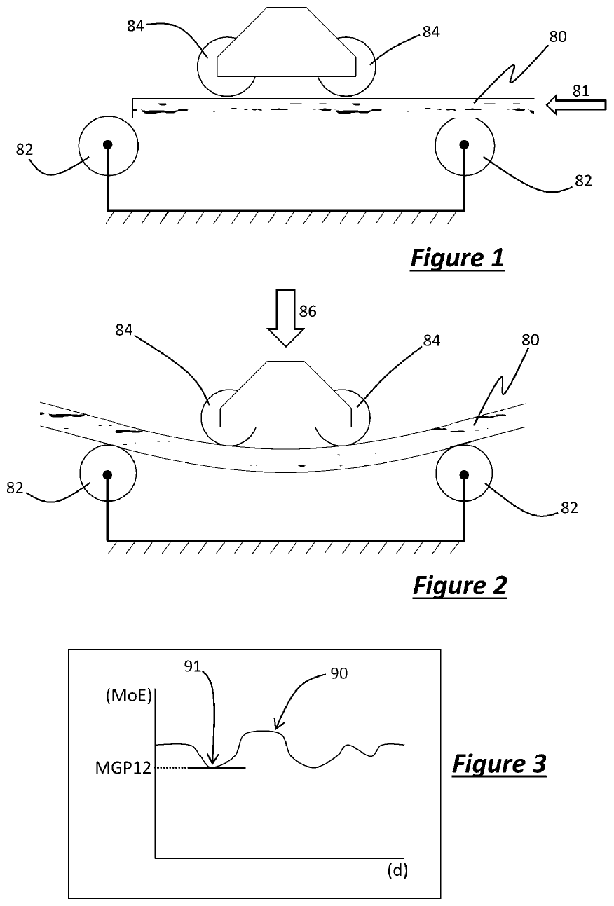

Timber machine grading is diagrammatically illustrated in FIGS. 1, 2 and 3. A timber stick 80 is longitudinally fed between two sets of rollers 82, 84, the flat sides of the timber facing the rollers (FIG. 1). As the timber stick 80 passes between the rollers a force (indicated by arrow 86) is applied through the rollers 84 to place a load on the section of the timber supported between the rollers 82 (FIG. 2). The load force and the resulting amount of deflection of the timber (minor axis bending) is used to estimate the modulus of elasticity (MoE) E as a continuous measurement along the length of the timber stick (apart from end portions where the timber does not extend the full length between rollers 82). The result is represented in a graph 90 shown in FIG. 3 illustrating the measurement indicative of modulus of elasticity (MoE) along the length (d) of the timber stick. The minimum 91 determines the stress grade allocated to that particular piece of timber, in this example MGP12.

Modern machine stress grading of timber is efficient for the timber mill insofar as timber can be graded quickly and without human expertise, as is required for visual grading. Nevertheless, a single flaw such as a knot or split on a particular timber stick can result in machine grading effectively discarding that timber as far as structural use is concerned. However, the present inventor has recognised that such timber can be put to structural use in a very efficient manner, as described herein.

Advanced engineered timber solutions use gluing, laminating and jointing techniques to increase the compressive and tensile strength of lower structural grade timbers and overcome natural weaknesses such as knots, warping, splitting and bowing. Materials include plywood, particleboard and fibreboard as well as engineered products such as glue laminated timber, laminated veneer lumber (LVL) and finger-jointed cladding or fascia.

Glulam, short for glued laminated timber, is an engineered timber product. In terms of structural use, engineered timber products such as glulam are typically employed as beams and other members in a frame construction. The manufacturing process produces large and long length glulam members from smaller pieces of stress graded seasoned timber. The high strength and stiffness of glulam enables large, unsupported spans to be constructed.

Embodiments of the present invention utilise glulam techniques in a different manner, to produce structural wall panels and the like from timber laminas that have not been able to be graded as MGP that would otherwise be suitable for structural use.

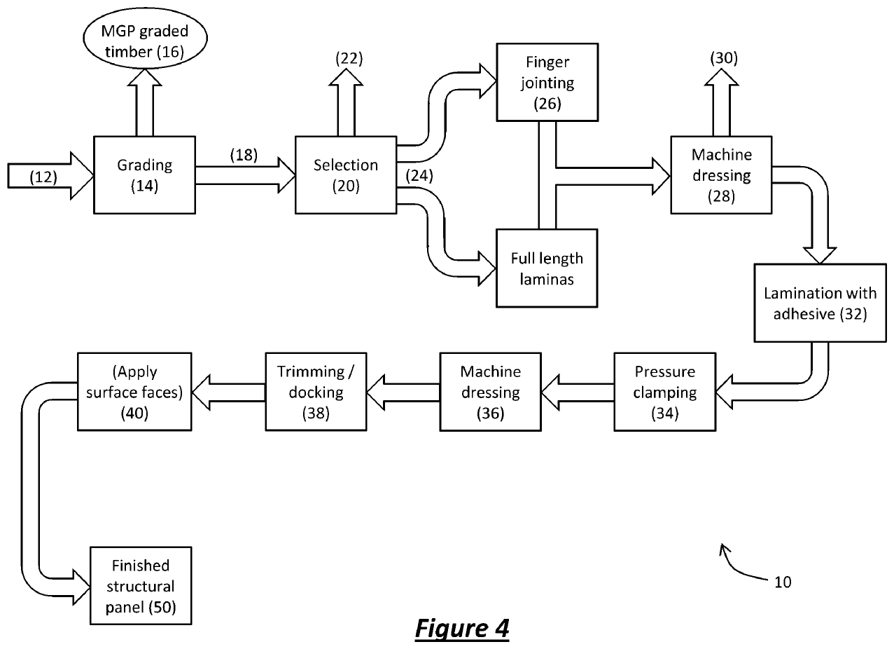

Details of the construction method (10) for producing such timberwork panels are set out below, with reference to the flow chart diagram presented in FIG. 4 of the accompanying drawings.

As outlined above, timber feedstock (12) is stress graded before being sold for use. The applications for which the timber is rated is determined by the stress grade allocated to it. For softwood timber species, the stress grade is typically allocated by a machine grading process (MGP) in accordance with Australian Standard AS 1748 (Timber—Solid—Stress-graded for structural purposes). Individual timber laminas that meet the objective requirements of the MGP grading process (14) are passed for use in structural applications (16). Timber laminas (18) that do not meet those requirements is sold as utility grade or merchant grade timber. It is kiln dried and has passed the full timber manufacturing process except that it has not been able to be graded as MGP suitable product.

Timber (24) from the non-structurally graded feedstock (18) are selected (20) for use in manufacturing panels according to embodiments of the invention. Certain timber (22) may be rejected for obvious flaws such as splitting, unsuitably warped or the like.

Full length timber or finger jointed timber laminas (sticks) are to be used to produce the panels. A finger joining process (26) is applied in accordance with GLTAA qualified glulam manufacturing processes, using Jowapur 686.20 polyurethane glue. Lamina are then machined (28) to a maximum of 42 mm thickness, to make up varying width of panels. Lamina (30) which have been split, or with excessive wain or machining want (allowable minimum ⅔ surface clean-up by width over maximum ⅓ of the laminate by length) are not to be used to produce panels.

To form the panels, the selected timber laminas are arranged in side-by-side parallel formation, without regard to any visual defects contained in the sticks. Jowapur 686.20 or 686.70 polyurethane glue is applied to laminates (32) prior to loading laminates into a press. Optionally, the individual lamina may also be nailed to adjacent layers. Pressure is applied to the laminates within the press (34) in accordance with GLTAA qualified glulam manufacturing processes. Once removed from presses, the panel surfaces may be dressed (36) and the panels are cut to required size (38). In some cases, a surface layer, such as plywood, may be applied (40) to one of both faces of the panel.

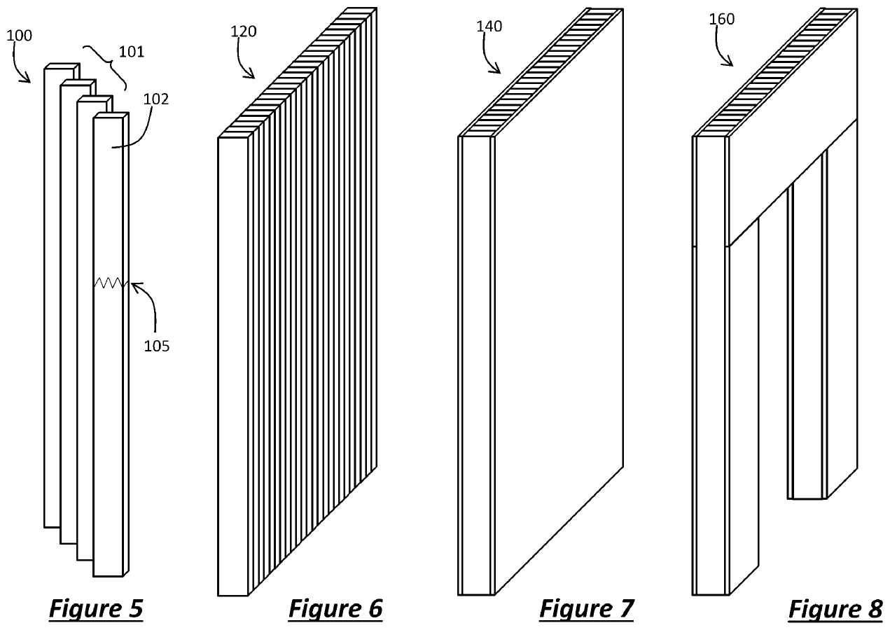

FIG. 5 illustrates timber feedstock 100 for use in forming panels according to embodiments of the invention, showing full length timber 101 and an example of a timber lamina 102 that has a finger joint at 105. According to one exemplary embodiment of the invention, the timber feedstock 100 comprises 90 mm×45 mm seasoned timber of 2950 mm lengths. It is of course possible to use other sizes/dimensions of timber feedstock (another example is 140 mm×45 mm) to form panels of various thicknesses, widths and lengths according to embodiments of the invention.

FIG. 6 illustrates an example of a completed panel 120 in which a plurality of timber laminas 100 have been laminated together. The panel 120 comprises twenty-two timber laminas 100 bonded together according to the process as described herein, with Jowapur one component polyurethane prepolymer adhesive as per AS/NZL 4364 to produce panels, in this instance, approximately 2950 mm high×950 mm wide.

FIG. 7 illustrates another example of a completed panel 140 in which a plurality of timber sticks 100 have been laminated together. The panel 140 comprises twenty-two timber sticks 100 glued and nail laminated together according to the process as described herein. The lamina are bonded using Bostik Ultraset adhesive in accordance with manufacturer's recommendation, with individual lamina additionally fixed to one another using power driven 75 mm bullet head nails at 300 mm spacing. The panel 140 further comprises 9 mm thick structural plywood applied to both faces (grain direction may be vertical or horizontal) using adhesive and 40-45 mm power driven flat-head nails.

FIG. 8 illustrates a panel 160, similar in construction to panel 140 but having a door opening formed therein. Other pre-formed wall panel structures can of course also be manufactured, for example with window apertures and the like.

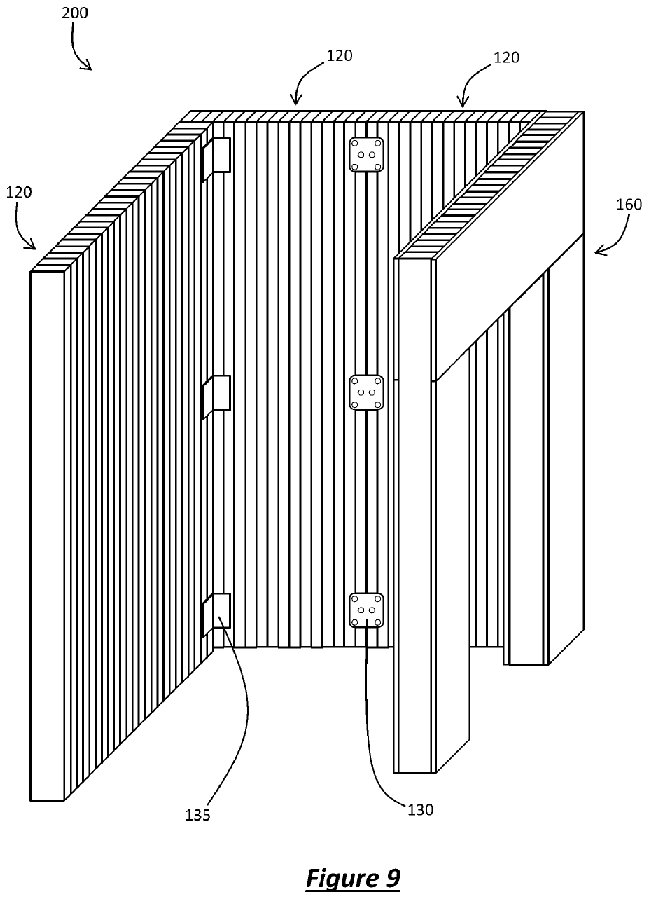

An example of a portion of a building structure 200 constructed from panels fabricated in accordance with embodiments of the invention is illustrated in FIG. 9. As can be seen, the individual laminas of the panels (120, 160) forming the walls of the structure 200 are oriented vertically. The individual panels may be interconnected to one another in a variety of different ways, in this case using plates 130, 135 that are each nailed or screwed to the two adjacent timber panels.

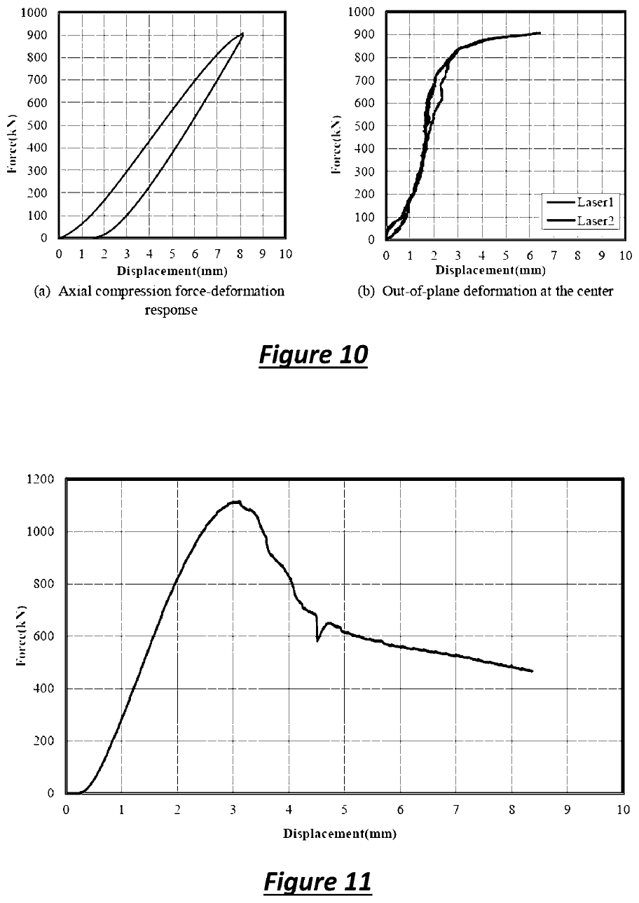

The structural characteristics of panels 120 have been tested for compression loading and in-plane shear/racking loading by a university to determine ultimate strength and serviceability limits in accordance with AS 1170.1 loading code. The testing results are outlined below, with reference to FIGS. 10, 11 and 12.

Timberwork panel samples were tested under static axial compression loading. The nominal length, width and thickness of the specimens tested were 2910 mm, 950 mm and 90 mm, respectively. The measured average moisture content of the specimens varied from 7.5% to 10.2%. Specimens were tested in a 1 MN MTS Universal Testing Machine (UTM) as shown in FIG. 3. The panels were tested under compression with simply supported boundary condition. Therefore, no rotational restraints existed at the top and bottom connections to the MTS machine. The test specimen was placed within a 125 PFC steel section with the specimen sandwiched between the flanges. The cavity within the flanges was 110 mm which provided a 20 mm tolerance fit to the specimens that were 90 mm thick. The UTM provided the force resistance and axial shortening. In addition, two optoNCDT 1302-200 mm laser extensometers were used to measure the out-of-plane deformation of the specimen at mid-height.

One result of axial compression force-deformation response is shown in FIG. 10(a). No sign of damage was observed as the specimen was pushed to a maximum of 90% of the testing machine capacity. The maximum axial compression force recorded was 906.8 kN that corresponded to 8.1 mm axial displacement. The out-of-plane movement recorded using the two lasers is shown in FIG. 10(b).

One specimen was tested under axial squash test, wherein a portion of the panel with dimensions 400×300×85 mm was subjected to compression by means of a 5 MN Instron Static Testing Machine. The force-displacement response of the specimen is shown in FIG. 11. The maximum axial compression force recorded was 1113.7 kN that corresponded to 3.1 mm axial displacement. The maximum stress under squash load is therefore:

$$σ = \frac{{P}_{max}}{A} = \frac{1113.7 \times {10}^{3}}{300 \times 85} = 43.7 MPa$$

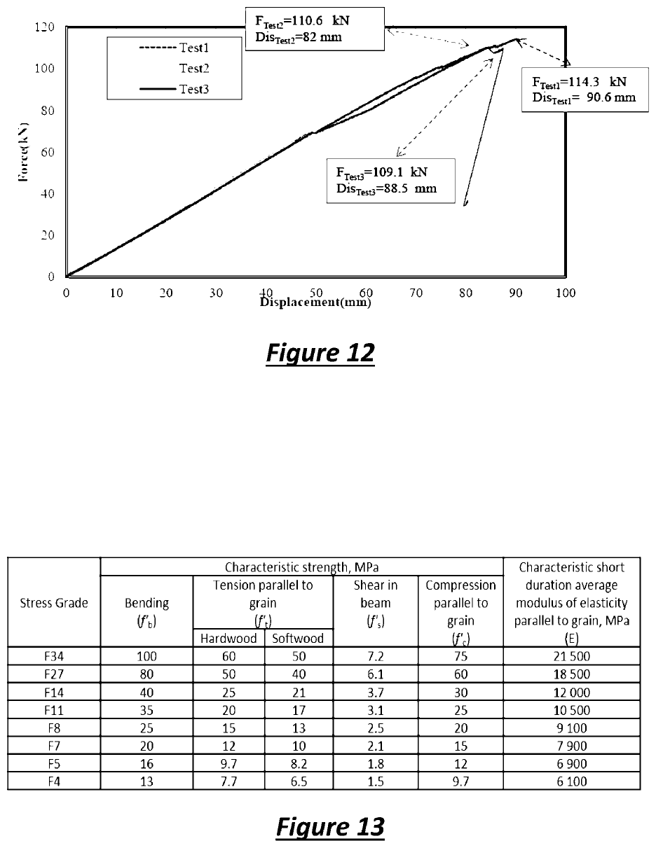

Three timberwork panel samples of the same dimensions specified above were tested under 4-point bending test. The average moisture content of the specimen was approximately 7.5%. The panels were tested as simply-supported beam elements subjected to the four-point bending tests. The symmetrical two-point loads on the top of the specimen were 900 mm apart, while the symmetrical two-point supports at the bottom were 2840 mm apart. The load was applied to the specimen by means of a 5 MN Instron Static Loading Machine, with one laser extensometer used to measure deformation of the specimen at the mid-length. The force versus mid-span deformation responses of the panels serving as simply-supported beam elements is shown in FIG. 12. The results of the bending tests were used to calculate the maximum flexural stress developed by the panels, with the results from the three test being:

$${σ}_{1} = 46.23 MPa$$

$${σ}_{2} = 44.72 MPa$$

$${σ}_{3} = 44.15 MPa$$

$${σ}_{average} = 45.00 MPa$$

For comparison, FIG. 13 indicates structural design properties for F-grade structural timbers. Based on the results of the testing, it can be seen that the panels constructed according to embodiments of the invention exhibit properties comparable with stress graded timbers in the region of F-14 to F-27.

The invention has been described by way of non-limiting example only and many modifications and variations may be made thereto without departing from the spirit and scope of the invention.

Any discussion of documents, devices, acts or knowledge in this specification is included to explain the context of the invention. It should not be taken as an admission that any of the material forms part of the prior art base or common general knowledge in the relevant art in Australia or elsewhere on or before the priority date of the disclosure and claims herein.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A method of manufacturing a structural panel for building construction, comprising: arranging timber laminas comprising non-structurally graded timber sticks, without regard to visual defects, in side-by-side parallel formation; and fabricating a structural panel wherein the timber laminas are arranged side-by-side parallel to one another with adhesive applied between each adjacent stick incorporated into a panel.

2. The method of claim 1, further comprising nailing adjacent laminas to one another in addition to applying adhesive.

3. The method of claim 1, further comprising affixing a sheet material, such as plywood, to one or both faces of the panel.

4. A timber panel for structural use in buildings, manufactured according to the method of claim 1.

5. A structural timber panel for building construction, wherein the structural timber panel is fabricated by: arranging timber laminas comprising non-structurally graded timber sticks, without regard to visual defects, in side-by-side parallel formation; and fabricating a structural panel wherein the timber laminas are arranged side-by-side parallel to one another with adhesive applied between each adjacent stick incorporated into the panel.

6. A building comprising one or more structural walls formed from at least one timber panel according to claim 5.

7. The method of claim 3, wherein said timber laminas consist of said non-structurally graded timber sticks.

8. The structural timber panel of claim 6, wherein said timber laminas consist of said non-structurally graded timber sticks.
